(19) United States
(12) Patent Application Publication
(10) Pub. No.: US 2013/0336492 A1
(43) Pub. Date: Dec. 19, 2013

(54) SYSTEM AND METHOD FOR IN-SITU EVALUATION OF AN IMPLANTABLE HEARING INSTRUMENT ACTUATOR

(71) Applicant: Julien Cevey, Montricher (CH)

(72) Inventor: Julien Cevey, Montricher (CH)

(73) Assignee: ADVANCED BIONICS AG, Staefa (CH)

(21) Appl. No.: 13/978,996

(22) PCT Filed: Jan. 10, 2011
(86) PCT No.: PCT/EP2011/050201

§ 371 Date: Sep. 5, 2013

(51) Int. Cl. H04R 25/00

(52) U.S. Cl. CPC H04R 25/30
USPC 381/60

(57) ABSTRACT

There is provided a system for in-situ evaluation of the performance of an actuator of a hearing instrument to be implanted in the middle ear cavity of a patient and to be mechanically coupled to an ossicle or to the cochlea, comprising: a hydrophone for being inserted into the middle ear cavity for picking up sound waves in the middle ear cavity generated by vibrations of the actuator and for providing for an output signal corresponding to the picked-up sound waves, and means for analyzing the output signals of the hydrophone in order to evaluate the actuator performance.

The invention relates to a method and system for in-situ evaluation of the performance of an actuator of a hearing instrument, which actuator is implanted in the middle ear cavity of a patient and is mechanically coupled to an ossicle or to the cochlea.

Fully or partially implantable hearing instruments comprise an implantable actuator which typically is implanted in the middle ear cavity of the patient and is mechanically coupled to an ossicle or to the cochlea, for example, via an artificial incus. The performance of the actuator, and in particular the coupling of the actuator to the coupling site, is crucial for the performance of the hearing instrument. Since correction of the actuator coupling after closing of the wound requires a new surgery, it is important that the actuator performance is evaluated in-situ during surgery.

A known method for such in-situ evaluation of actuator performance uses a laser Doppler vibrometer (LDV) device, wherein the vibrations caused by the implanted actuator are sensed by a laser beam which impinges through the ear canal and which is reflected or scattered at a vibrating component of the patient's ear. The collected data is analyzed in order to evaluate the actuator performance. However, such LDV devices are costly and complex equipment which is difficult to use.

Another known way to obtain information on actuator performance is to place a microphone in the ear canal in order to receive feedback from a middle ear implant through the tympanic membrane. An example of such method is described in EP 1 251 810 B1.

It is an object of the invention to provide for a system for in-situ evaluation of the performance of a hearing instrument actuator implanted in the middle ear cavity, wherein the system should be relatively inexpensive, small and easy to use, while nevertheless providing for relatively accurate evaluation of the actuator performance. It is also an object to provide for a corresponding evaluation method.

According to the invention, these objects are achieved by a system as defined in claim 1 and a method as defined in claim 6, respectively.

The invention is beneficial in that, by using a hydrophone in the middle ear cavity for picking up sound waves generated by vibration of the actuator, the system can be kept relatively simple—compared, for example, to an LDV device—thereby reducing costs and achieving easy handling of the system in the operating room. Compared to a microphone, the use of a hydrophone is beneficial in that a hydrophone is able to measure pressure waves inside a “dirty” environment, like blood or physiological liquids, which typically is found at the part of the body where surgery takes place.

In order to improve the acoustic coupling between the actuator and the hydrophone during measurement, the middle ear cavity can be filled with a biocompatible liquid from an external source, for example a physiological liquid, with both the actuator coupling site and the hydrophone being immersed in the liquid.

Preferred embodiments of the invention are defined in the dependent claims.

Hereinafter, an example of the invention will be illustrated by reference to the attached drawings, wherein:

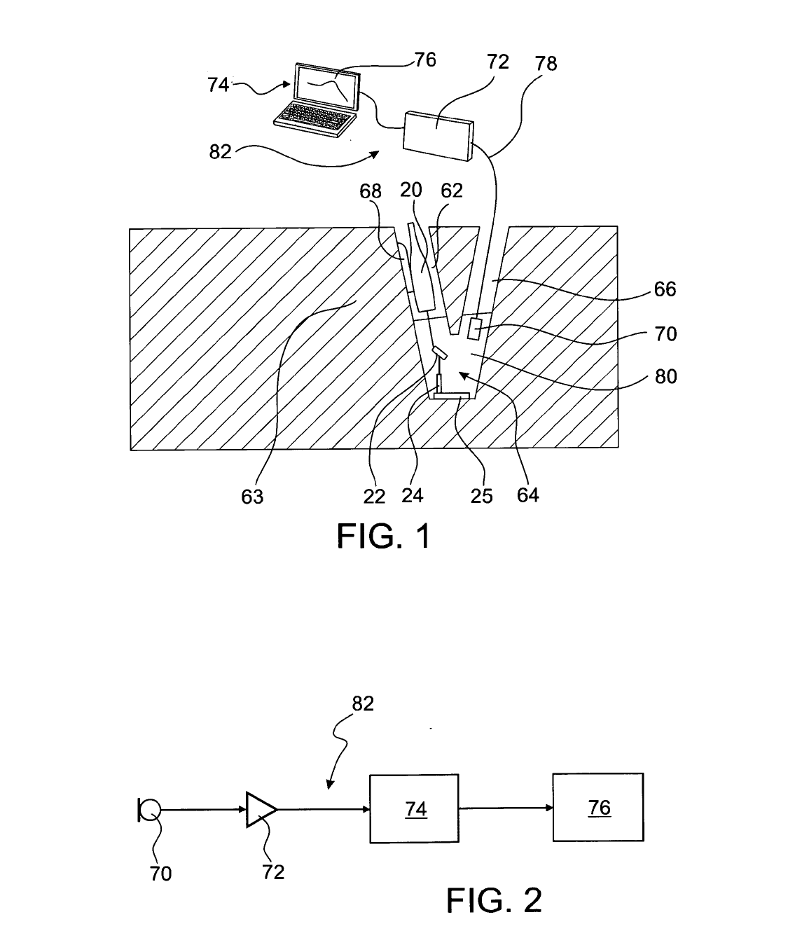

FIG. 1 is a schematic cross-sectional view of the middle ear cavity of a patient during implantation of an actuator, when actuator performance is evaluated by a system according to the invention;

FIG. 2 is a schematic block diagram of an evaluation system according to the invention;

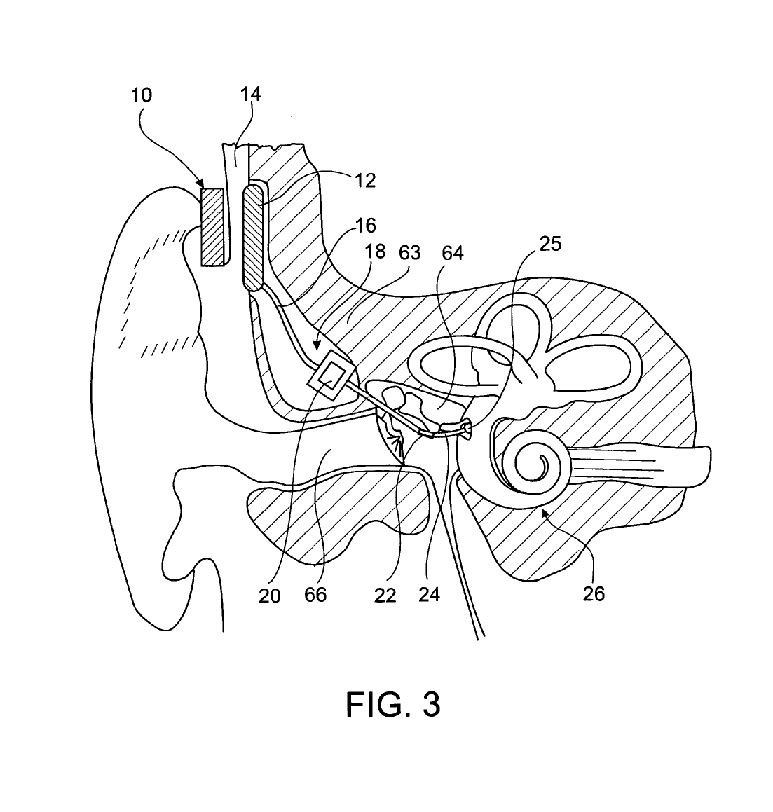

FIG. 3 is a cross-sectional view of an example of a hearing instrument, which may be evaluated by using the present invention, after implantation; and

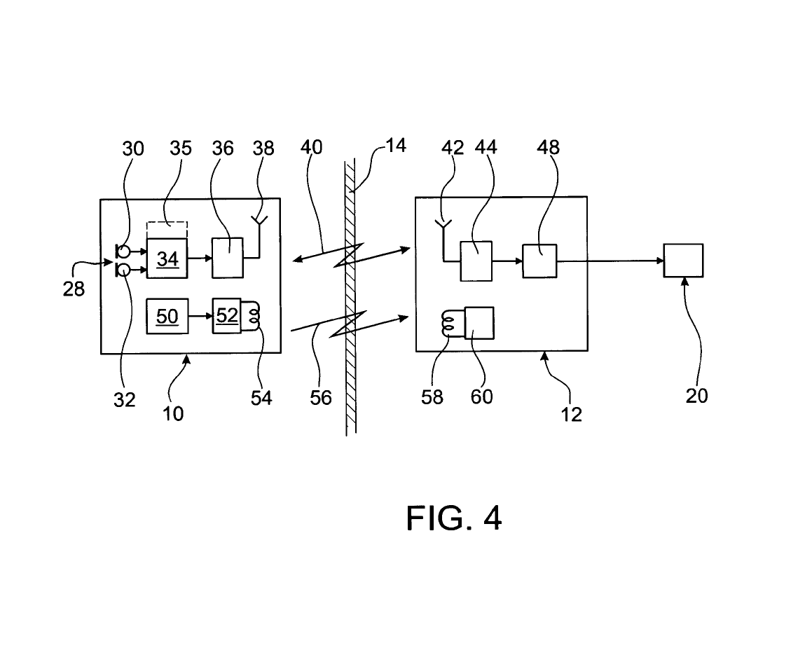

FIG. 4 is a block diagram of the hearing instrument of FIG. 3.

FIG. 3 shows a cross-sectional view of the mastoid region, the middle ear and the inner ear of a patient after implantation of an example of a hearing instrument which can be evaluated by a system according to the invention, wherein the hearing instrument is shown only schematically. The hearing instrument comprises an external unit 10 which is worn outside the patient's body at the patient's head, typically close to the ear, and an implantable unit 12 which is implanted under the patient's skin 14, usually in an artificial cavity created in the user's mastoid. The implantable unit 12 is connected, via a cable assembly 16, to a stimulation assembly 18 comprising an electromechanical actuator 20 for stimulating the cochlea 26 via a lever element 22 which forms an artificial incus to which a stapes prosthesis 24 mounted at the stapes footplate 25 is crimped to.

The external unit 10 is fixed at the patient's skin 14 in a position opposite to the implantable unit 12, for example, by magnetic forces created between at least one fixation magnet provided in the external unit 10 and at least one co-operating fixation magnet provided in the implantable unit 12 (the magnets are not shown in FIG. 3).

An example of a block diagram of the system of FIG. 3 is shown in FIG. 4. The external unit 10 includes a microphone arrangement 28, which typically comprises at least two spaced-apart microphones 30 and 32 for capturing audio signals from ambient sound, which audio signals are supplied to an audio signal processing unit 34, wherein they undergo, for example, acoustic beam forming. The processed audio signals are supplied to a transmission unit 36 connected to a transmission antenna 38 in order to enable transcutaneous transmission of the processed audio signals via an inductive link 40 to the implantable unit 12 which comprises a receiver antenna 42 connected to a receiver unit 44 for receiving the transmitted audio signals. The received audio signals are supplied to a driver unit 48 which drives the actuator 20.

The external unit 10 also comprises a power supply 50 which may be a replaceable or rechargeable battery, a power transmission unit 52 and a power transmission antenna 54 for transmitting power to the implantable unit 12 via a wireless power link 56. The implantable unit 12 comprises a power receiving antenna 58 and a power receiving unit 60 for powering the implanted electronic components with power received via the power link 56.

Preferably, the audio signal antennas 38, 42 are separated from the power antennas 54, 58 in order to optimize both the audio signal link 40 and the power link 56. However, if a particularly simple design is desired, the antennas 38 and 54 and the antennas 42 and 58 could be physically formed by a single antenna, respectively.

FIG. 1 is a schematic view of a patient's ear during implantation of the actuator 20 of the hearing instrument. For implanting the actuator 20, an artificial cavity 62 is drilled into the temporal bone 63 in order to provide an access to the middle ear cavity 64. For example, the artificial cavity 62 may have the shape of a tunnel extending essentially parallel to the ear canal 66. In addition, the ear canal 66 is prepared by surgery for providing an additional access to the middle ear cavity 64, wherein the tympanic membrane is opened. After having been inserted into the artificial cavity 62, the actuator 20 is fixed at the temporal bone 63 via a fixation system 68. A stapes prosthesis 24 is inserted through an artificial hole in the stapes footplate 25 into the cochlea 26 and is crimped to the artificial incus 22.

An example of an in-situ actuator performance evaluation system 82 is shown in FIGS. 1 and 2, which comprises a hydrophone 70, an amplifier unit 72, a signal analyzing unit 74 and a display unit 76. The hydrophone 70 is connected to the amplifier unit 72 via a cable connection 78. For in-situ evaluation of the actuator performance, the hydrophone 70 is inserted into the middle ear cavity 64 through the ear canal 66 and is placed in close proximity to the artificial incus 22 in order to pick up sound waves in the middle ear cavity 64 generated by the output of the actuator 20, i.e. by vibration of the artificial incus 22. In order to promote the acoustic coupling between the actuator output and the hydrophone 70, the middle ear cavity 64 may be filled with a biocompatible liquid 80 which may be, for example, a physiological liquid. The hydrophone 70 transforms the picked-up sound waves into an output signal which is amplified in the amplifier unit 72 and then is supplied to the analyzing unit 74 where it undergoes some signal processing in order to enable an evaluation of the performance of the actuator 20. Such signal processing may include transformation of the signal into the frequency domain in order to provide for a spectral analysis of the actuator output. The display unit 76 serves to display the result of the analysis of the output signals of the hydrophone 70 to the surgeon. In particular, the in-situ evaluation system 82 can be used for measuring the transfer function at the output of the actuator 20.

A first measurement already may be performed before the artificial incus 22 is connected to the stapes prosthesis 24 in order to ensure that the actuator 20 has not been damaged during implantation. A second measurement may be performed after the artificial incus 22 has been coupled to the stapes prosthesis 24.

The output of the actuator 20 used for the hydrophone measurements preferably corresponds to a predefined noise signal which is constant and which may be, for example, white noise.

The respective test/noise signal may be generated in the external unit 10, for example, by a signal generator 35 of the audio signal processing unit 34. According to one embodiment, a special type of the external unit 10 may be used for the evaluation measurements of the performance evaluation system 82, which type of external unit 10 differs from the type of external unit 10 used during normal operation of the hearing instrument (for example, the external unit 10 used for the tests does not need the microphone arrangement 28).

Preferably, the hydrophone 70 is able to pick up sound waves over the entire frequency range of the actuator 20 which typically extends up to about 10 kHz.

Preferably, the hydrophone is a needle hydrophone, which may be obtained, for example, from Precision Acoustic Ltd, Dorchester, U.K

It is to be understood that the evaluation system and method of the present invention can be applied not only to the type of hearing instrument described so far. Rather, the present invention is useful for any type of implantable actuator which is located in the middle ear cavity and which is mechanically coupled to an ossicle or to the cochlea.

1. A system for in-situ evaluation of a performance of an actuator of a hearing instrument to be implanted in a middle ear cavity of a patient and to be mechanically coupled to an ossicle or to a cochlea (25, 26), comprising:
a hydrophone for being inserted into the middle ear cavity for picking up sound waves in the middle ear cavity generated by vibrations of the actuator and for providing for an output signal corresponding to picked-up sound waves, and
means for analyzing output signals of the hydrophone in order to evaluate the actuator performance.

2. The system of claim 1, wherein the hydrophone is designed to pick-up sound waves over an entire frequency range of the actuator.

3. The system of claim 1, wherein the analyzing means are adapted for analysis in a frequency domain.

4. The system of claim 1, further comprising means for displaying a result of an analysis of the output signals of the hydrophone to a surgeon.

5. The system of claim 1, wherein the hydrophone is a needle hydrophone.

6. A method of in-situ evaluation of a performance of an actuator of a hearing instrument, comprising:
creating an access to a patient's middle ear cavity;
implanting the actuator in the middle ear cavity and mechanically coupling the actuator to an ossicle or to a cochlea;
placing a hydrophone in the middle ear cavity;
generating a vibrational output of the actuator;
measuring a vibrational output of the actuator by picking up sound waves generated by the vibrational output of the actuator by the hydrophone; and
evaluating the actuator performance based of output signals of the hydrophone corresponding to picked-up sound waves.

7. The method of claim 6, wherein the middle ear cavity is filled with a biocompatible liquid from an external source for measuring the vibrational output of the actuator.

8. The method of claim 7, wherein the biocompatible liquid is a physiological liquid.

9. The method of 6, wherein the vibrational output of the actuator corresponds to a predefined noise signal.

10. The method of claim 9, wherein the predefined noise signal is constant.

11. The method of claim 9, wherein the predefined noise signal is white noise.

12. The method of claim 6, wherein the actuator comprises an artificial incus to which a stapes prothesis is crimped.

13. The method of claim 6, wherein the hydrophone is inserted into the middle ear cavity through an ear canal.
